(19) United States
(12) Patent Application Publication
(10) Pub. No.: US 2026/0087961 A1
(43) Pub. Date: Mar. 26, 2026

(54) DISPLAY DEVICE AND DISPLAY METHOD THEREOF

(71) Applicant: Coretronic Corporation, Hsin-Chu (TW)

(72) Inventors: Pen-Ning Kuo, Hsin-Chu (TW); Kai-Hao Chang, Hsin-Chu (TW); Ming-Chi Tang, Hsin-Chu (TW)

(73) Assignee: Coretronic Corporation, Hsin-Chu (TW)

(21) Appl. No.: 19/310,868

(22) Filed: Aug. 26, 2025

Related U.S. Application Data
(60) Provisional application No. 63/698,051, filed on Sep. 24, 2024.

(30) Foreign Application Priority Data
Dec. 20, 2024 (CN) 202411889045.9

(51) Int. Cl. G09G 3/20; G09G 3/00; G09G 3/36; H04N 9/31

(52) U.S. Cl. CPC G09G 3/2044; G09G 3/001; G09G 3/36; H04N 9/3197

(57) ABSTRACT

A display device and a display method of the display device are provided. A sub-image generation module generates a plurality of sub-image signals based on a received image signal. A dithering module adjusts a grayscale value of a target adjustment pixel in the sub-image signals based on a blue noise mask and a gray level lookup table. A control unit controls an image displayed by an image unit based on the grayscale value of the target adjustment pixel.

### CROSS-REFERENCE TO RELATED APPLICATION

This application claims the priority benefit of a U.S. provisional application Ser. No. 63/698,051, filed on Sep. 24, 2024, and China application serial no. 202411889045.9, filed on Dec. 20, 2024. The entirety of each of the above-mentioned patent applications is hereby incorporated by reference herein and made a part of this specification.

### BACKGROUND OF THE INVENTION

### Field of the Invention

The invention relates to an electronic device, and more particularly to a display method of a display device.

### Description of Related Art

In the image display technology of display devices (such as projectors or liquid crystal displays), due to the uneven distribution of color levels in images displayed by the display devices and the inability to effectively create more grayscale levels, effectiveness in image display performance cannot be guaranteed.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY OF THE INVENTION

One or more embodiments of the invention provides a display method of a display device, which can effectively create more grayscale levels, significantly improving the display quality of the display device.

The other objectives and advantages of the invention may be further understood from the technical features disclosed in the invention.

In order to achieve one, some, or all of the aforementioned objectives or other objectives, an embodiment of the invention provides a display device that includes a sub-image generation module, a dithering module, a control unit, and an image unit. The sub-image generation module is configured to generate a plurality of sub-image signals based on a received image signal. The dithering module is coupled to the sub-image generation module, and the dithering module includes a blue noise mask and a gray level lookup table. The dithering module is configured to adjust a grayscale value of a target adjustment pixel in the sub-image signals based on the blue noise mask and the gray level lookup table. The control unit is coupled to the dithering module and the image unit, and the control unit is configured to control an image displayed by an image unit based on the grayscale value of the target adjustment pixel.

In order to achieve one, some, or all of the aforementioned objectives or other objectives, another embodiment of the invention provides a display method of a display device, and the display method includes following steps. A plurality of sub-image signals are generated by a sub-image generation module based on a received image signal. A grayscale value of a target adjustment pixel in the sub-image signals are adjusted by a dithering module based on a blue noise mask and a gray level lookup table. An image displayed by an image unit is controlled by a control unit based on the grayscale value of the target adjustment pixel.

In view of the above, according to one or more embodiments of the invention, the sub-image generation module generates a plurality of sub-image signals based on the received image signal, the dithering module adjusts the grayscale value of the target adjustment pixel in the sub-image signals based on the blue noise mask and the gray level lookup table, and the control unit controls the image displayed by the image unit based on the grayscale value of the target adjustment pixel. This may effectively increase the number of grayscale levels and significantly improve the display quality of the display device.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a display device according to an embodiment of the invention.

FIG. 2 is a schematic diagram of a dithering module and a control unit according to an embodiment of the invention.

FIG. 3A and FIG. 3B are schematic diagrams of sub-blue noise masks applied to sub-image signals corresponding to different time points under different grayscale levels according to an embodiment of the invention.

FIG. 4 is a schematic diagram of a gray level lookup table according to an embodiment of the invention.

FIG. 5 is a schematic diagram of sub-blue noise masks corresponding to different time points and different frame rate conversion intensity values according to an embodiment of the invention.

FIG. 6 is a schematic diagram of a blue noise mask lookup table according to an embodiment of the invention.

FIG. 7 is a schematic diagram illustrating a position of a target adjustment pixel in an image signal according to an embodiment of the invention.

FIG. 8 is a flowchart of a display method of a display device according to an embodiment of the invention.

FIG. 9 and FIG. 10 are flowcharts of a method of adjusting a grayscale value of a target adjustment pixel according to an embodiment of the invention.

### DESCRIPTION OF THE EMBODIMENTS

It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. The use of “at least one of . . . and . . . ” thereof herein is meant to “one or more of one or more of the items contained in the list”. For example, the use of “at least one of A and B” thereof herein is meant to encompass only “A”, or only “B”, or “A and B”. Similarly, the use of “at least one of A, B, and C” thereof herein is meant to encompass only “A”, or only “B”, or only “C”, or “any combination of A, B, and C”.

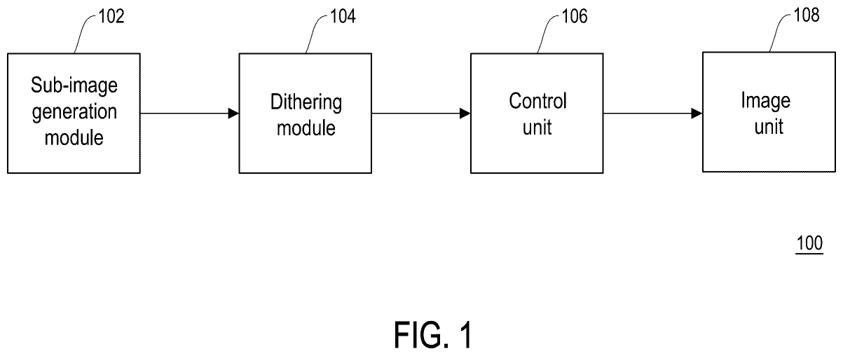

FIG. 1 is a schematic diagram of a display device according to an embodiment of the invention. Please refer to FIG. 1. A display device 100 may be, for instance, a projection device (such as a projector) or a display (such as a liquid crystal display). The display device 100 may include a sub-image generation module 102, a dithering module 104, a control unit 106, and an image unit 108. The dithering module 104 is coupled to the sub-image generation module 102. The control unit 106 is coupled to the dithering module 104 and the image unit 108. The sub-image generation module 102 may generate “n” sub-image signals based on a received image signal (for instance, the image signal may have a 1080P native resolution and a 60 fps frame rate, which should however not be construed as a limitation), where “n” is an integer greater than or equal to 1 (e.g., 2, 4, or 8). For instance, one frame in the image signal may be divided into 2, 4, or 8 sub-frames to form a plurality of sub-image signals provided to the dithering module 104 for processing. In one embodiment, the sub-image generation module 102 may be, for instance, a sub-image processing module, which may be configured to divide one frame in the image signal (e.g., a 1080P/30 or 60 fps image signal, which should however not be construed as a limitation) into “n” (e.g., 4 or 8) identical sub-frames (e.g., with the same pixel data). In another embodiment, when the display device 100 is a projection device with a 4K (2160P) resolution, the sub-image generation module 102 may be, for instance, an XPR 4P (expanded Pixel Resolution 4P) module, which may be configured to divide one frame in the image signal (e.g., a 2160P/60 fps image signal, which should however not be construed as a limitation) into “n” (e.g., 4) different sub-frames (e.g., with pixel-shifted or time-divided data). The sub-image generation module 102 may be coupled to a signal input terminal (such as a HDMI port or a display port) to obtain the image signal. In one embodiment, the sub-image generation module 102, the dithering module 104, and the control unit 106 may each include at least one processor. The at least one processor may be a field programmable gate array (FPGA), a microcontroller (MCU), or any other device with computational processing capabilities. The number of processors may be one or more. In one embodiment, at least two of the sub-image generation module 102, the dithering module 104, and the control unit 106 may be integrated into the same processor (e.g., a field programmable gate array, FPGA).

The dithering module 104 may include a blue noise mask and a gray level lookup table (LUT). For instance, the blue noise mask and the gray level LUT may be stored in a storage unit (not shown in the figure) in the dithering module 104 or in a storage unit (e.g., a storage medium, not shown in the figure) coupled to the dithering module 104. The dithering module 104 may adjust a grayscale value of a target adjustment pixel in the sub-image signals based on the blue noise mask and the gray level LUT. The control unit 106 may control the image displayed by the image unit 108 based on the grayscale value of the target adjustment pixel. In an embodiment where the display device 100 is a projection device, the control unit 106 is a light valve controller (e.g., a digital light processing controller, DLPC), and the image unit 108 is a light valve. The light valve controller may control the micro-mirror flipping of the light valve based on the grayscale value of the target adjustment pixel, so as to convert the illumination beam into an image beam and project the image beam out of the projection device through a projection lens. In an embodiment where the display device 100 is a display, the control unit 106 may be a display controller (such as a liquid crystal controller), and the image unit 108 may be a display panel (such as a liquid crystal panel).

As such, by generating the sub-image signals from the received image signal through the sub-image generation module 102, and applying temporal dithering and spatial dithering using the blue noise mask and the gray level LUT of the dithering module 104, more grayscales may be effectively created, thereby significantly enhancing the display quality of the display device 100.

In this embodiment, the dithering module 104 may generate a plurality of sub-blue noise masks based on the blue noise mask, obtain a corresponding mask value from the blue noise mask based on the position of the target adjustment pixel in the corresponding sub-image signal, obtain a frame rate conversion (FRC) intensity value, a spatial sub-intensity value, a first grayscale value, and a second grayscale value corresponding to the original grayscale value of the target adjustment pixel based on the gray level LUT, perform a logic operation based on the mask value, the FRC intensity value, and the spatial sub-intensity value, and adjust the grayscale value of the target adjustment pixel to either the first grayscale value or the second grayscale value based on a result of the logic operation, where the first grayscale value may be different from the second grayscale value (except for the situation where the original grayscale value is 0). The first grayscale value may be less than or equal to the second grayscale value. In the event that the first grayscale value is less than the second grayscale value, the first grayscale value may, for instance, serve to display pixels with a “dark” status, and the second grayscale value may, for instance, serve to display pixels with a “bright” status.

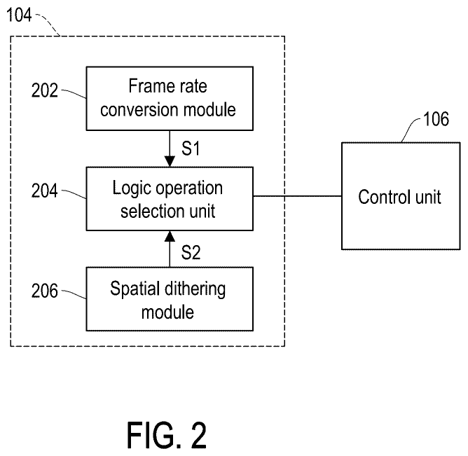

For instance, the dithering module 104 may include an FRC module 202, a logic operation selection unit 204, and a spatial dithering module 206, as shown in FIG. 2. The FRC module 202, the logic operation selection unit 204, and the spatial dithering module 206 may be, for instance, integrated into the same processor. The FRC module 202 and the spatial dithering module 206 are electrically connected to the logic operation selection unit 204. For example, when “n” is equal to 8, and the sub-image generation module 102 may divide the image signal into 8 sub-image signals to allow the dithering module 104 to perform temporal dithering and spatial dithering.

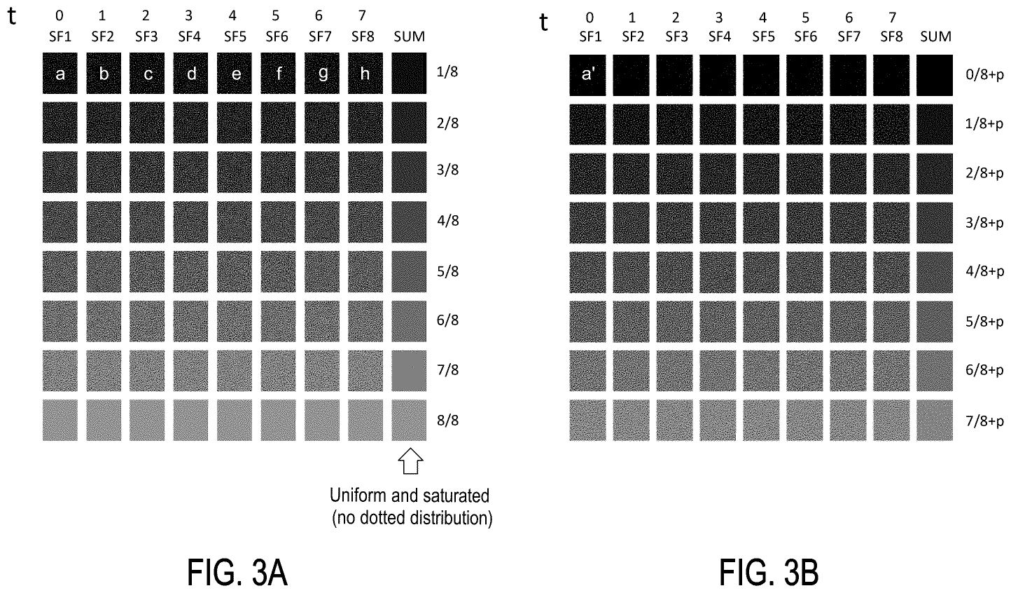

At the initial grayscale level, the dithering module 104 may divide the blue noise mask into “n” (for instance, 8) non-overlapping (initial) sub-blue noise masks, and at least one of the sub-blue noise masks may be applied to the sub-image signal. At the initial grayscale level, the number of (initial) sub-blue noise masks “a” to “h” is, for instance, equal to the number of sub-image signals. FIG. 3A is a schematic diagram illustrating sub-image signals SF1 to SF8 applying different sub-blue noise masks under different grayscale levels at 8 time points t=0 to 7. In one embodiment, the blue noise mask may be, for instance, further divided into (non-initial) sub-blue noise masks corresponding to “n” grayscale levels (e.g., evenly dividing from the lowest grayscale to the highest grayscale values into “n” parts), so that the sub-blue noise masks may be applied to sub-image signals SF1 to SF8 depending on different grayscale levels. For instance, ranging from the first grayscale level (initial grayscale level 1/n) to the nth grayscale level (n/n), the nth grayscale level is the brightest level. Each sub-blue noise mask may, for instance, have 64 pixels, and the blue noise mask may, for instance, have 64×64 pixels depending on the type (number) and the grayscale level of the sub-blue noise mask. When “n” is equal to 8, for instance, and the sub-blue noise masks “a” to “h” in the first row corresponding to the grayscale level of ⅛ are obtained by performing temporal dithering on the sub-image signals SF1 to SF8 at time points t=0 to 7 using the blue noise mask; that is, the sub-blue noise masks “a” to “h” are applied to “n” (for instance, 8) sub-image signals SF1 to SF8, respectively. The ratio of the number of pixels with the “bright” status in each of the sub-blue noise masks “a” to “h” to the total number of the pixels is ⅛, and there is no overlapping region where the pixels in the sub-blue noise masks “a” to “h” have the “bright” status, which means that the sub-blue noise masks “a” to “h” are mutually exclusive subsets.

The FRC module 202 may generate (non-initial) sub-blue noise masks corresponding to other (different) grayscale levels (e.g., 2/8 to 8/8) by performing logic operations (for instance, “OR” operations) on the sub-blue noise masks “a” to “h”. When the grayscale level is a non-initial grayscale level 2/n to n/n, at each time point “t”=0 to 7, at least two of the sub-blue noise masks “a” to “h” are applied; that is, the (non-initial) sub-blue noise masks are a combination of at least two of the sub-blue noise masks “a” to “h”. For instance, in FIG. 3A, at the time point t=0, the mask (combination) at the second grayscale level 2/8 may be obtained by performing an “OR” operation on the sub-blue noise masks “a” and “b”, resulting in a combination of the sub-blue noise masks “a” and “b”. As such, from the first grayscale level (the initial grayscale level, 1/n) to the nth grayscale level (n/n), one or more sub-blue noise masks may be applied to each sub-image signals SF1 to SF8 at each time point t=0 to 7. By superimposing the sub-image signals SF1 to SF8 at different time points t=0 to 7, an image signal SUM with uniform, saturated, and without a dotted distribution may be obtained.

To further subdivide the grayscale levels presentable by the image signal, additional grayscale levels may be inserted between the adjacent predefined grayscale levels, such as between 0/8-1/8, 1/8-2/8, 2/8-3/8, 3/8-4/8, 4/8-5/8, 5/8-6/8, 6/8-7/8, and 7/8-8/8. The spatial dithering module 206 may be configured to adjust the proportion of pixels having a “bright” display status within in the sub-blue noise masks, thereby enabling finer grayscale divisions.

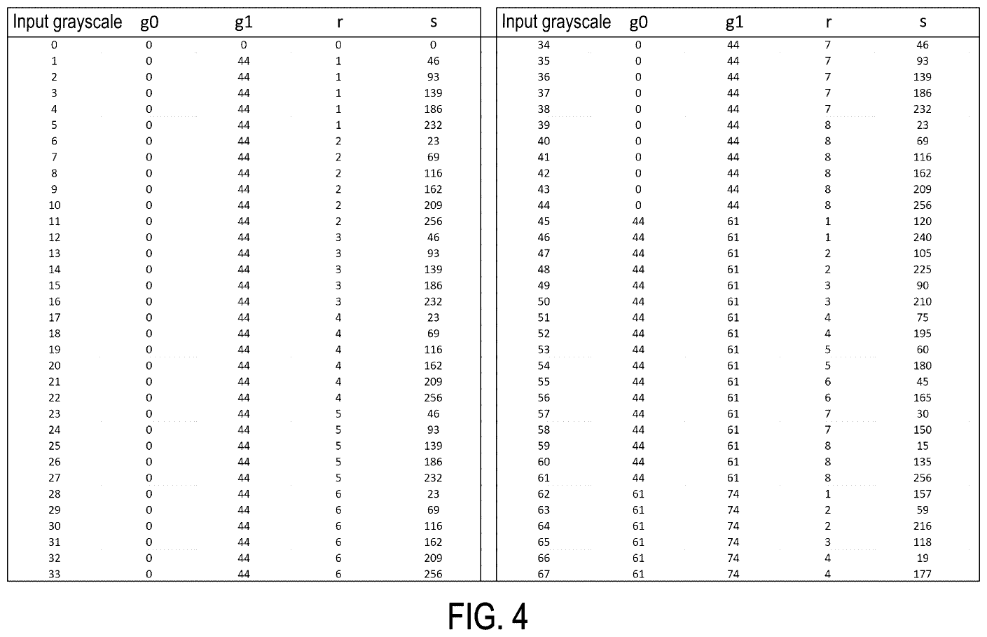

The sub-blue noise mask “a” in FIG. 3A is taken as an example, and the proportion of pixels with a bright status (a display status of being “bright”) in the sub-blue noise mask “a” is 1/8. Based on the sub-blue noise mask “a”, the proportion of pixels with a bright status in the sub-blue noise mask “a” may be reduced according to a spatial sub-intensity value “s”. The spatial sub-intensity value “s” may be obtained, for instance, based on the gray level LUT shown in FIG. 4. For instance, with an input grayscale (the original grayscale value of the target adjustment pixel) of 18, a corresponding first grayscale value “g0” equals 0, a second grayscale value “g1” equals 44, an FRC intensity value “r “equals 4, and the spatial sub-intensity value “s” equals 69. Here, the FRC intensity value “r” is related to the grayscale level, while the spatial sub-intensity value “s” is related to the number of pixels with a bright status in the spatial distribution. A relatively large spatial sub-intensity value “s” indicates a relatively large number of pixels with a bright status in the spatial distribution, with “s”=256 being the maximum value.

Assuming that the spatial sub-intensity value “s” of the sub-blue noise mask “a” shown in FIG. 3A is 256, the proportion of pixels with a bright status may be reduced according to a lower spatial sub-intensity value (for instance, s=64). This results in a new sub-blue noise mask “a” as shown in FIG. 3B. The grayscale level of the original sub-blue noise mask “a” is reduced from the initial grayscale level 1/n to (0/n)+p (e.g., the grayscale level (0/8)+p), where “p” equals the spatial sub-intensity value divided by 256 and then divided by “n” (where p=(s/256)/n). In the case where the spatial sub-intensity value is 64, “p” equals 1/32. Similarly, the grayscale values of the other sub-blue noise masks in FIG. 3A may be adjusted in a similar manner to obtain the corresponding sub-blue noise masks in FIG. 3B.

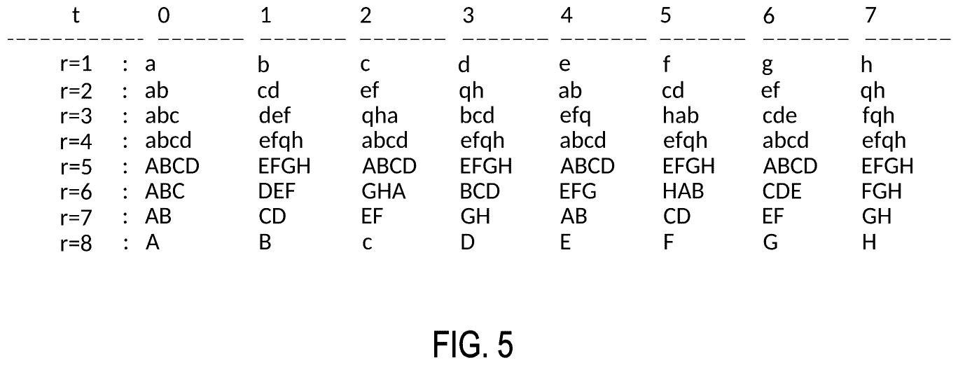

For instance, the FRC module 202 may determine the corresponding sub-blue noise mask based on the relationship between the time point “t” and the FRC intensity value “r” as shown in FIG. 5, which may be one (initial) of the sub-blue noise masks “a” to “h” or a combination of plural (initial) sub-blue noise masks “a” to “h” (the (non-initial) sub-blue noise masks). In FIG. 5, “a” to “h” represent the sub-blue noise masks “a” to “h”, respectively, while “A” to “H” represent results of inverse operations on the sub-blue noise masks “a” to “h” (e.g., A=not (a), B=not (b), C=not (c), and so on). Accordingly, each inverse mask (e.g., A=not (a)) may be implemented as a logical combination (e.g., an OR operation) of the other sub-blue noise masks (e.g., “b” to “h”), which are defined as mutually exclusive subsets. In other words, in the (initial) sub-blue noise mask “a” and the (non-initial) sub-blue noise mask A (the combination of the sub-blue noise masks “b” to “h”), pixels at the same position have the opposite display status (for instance, a pixel at the same position in the sub-blue noise mask “a” has a status of being “bright”, while a pixel at the same position in the sub-blue noise mask “A” has a status of being “dark”).

The FRC module 202 may determine, based on the target adjustment pixel at the target time point “t”, at least one of the sub-blue noise masks corresponding to the FRC intensity value “r” of the target adjustment according to a correspondence table shown in FIG. 5, where each FRC intensity value “r” (e.g., r=1 to 8) corresponds to at least one of the sub-blue noise masks “a” to “h” at different time points t=0 to 7. Each of the sub-blue noise masks “a” to “h” has a corresponding sequence of mask values. The FRC module 202 may determine whether the mask value of the target adjustment pixel falls within the sequence of mask values of the sub-blue noise mask corresponding to the FRC intensity value, so as to generate a first signal S1. The first signal S1 indicates whether the mask value of the target adjustment pixel falls within the sequence of mask values of at least one of the sub-blue noise masks corresponding to the target time point “t” and the FRC intensity value “r”. The sequence of mask values includes a plurality of values, and the values in the sequence of mask values of each of the blue noise masks “a” to “h” are defined as mutually disjoint subsets. The values may be consecutive integers or non-consecutive integers, and may have regularity or irregularity.

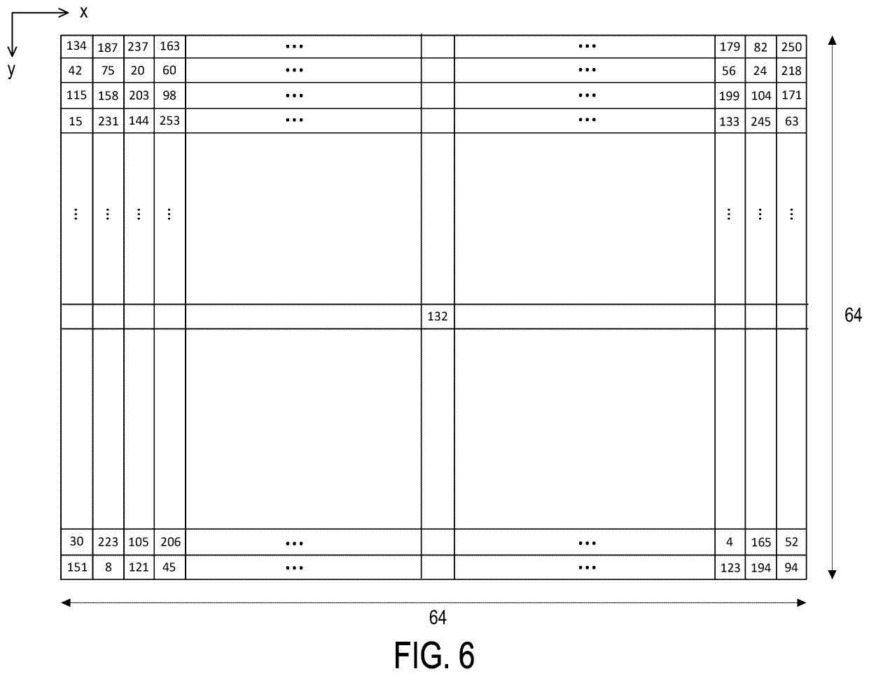

For instance, with reference to FIG. 4, the FRC module 202 may obtain the FRC intensity value “r” corresponding to the input grayscale through the gray level LUT. When the FRC intensity value “r” corresponding to the input grayscale (the original grayscale value of the target adjustment pixel) is equal to 2, and the combination of the sub-blue noise masks corresponding to the target time point t=1 and the FRC intensity value r=2 includes the sub-blue noise masks “c” and “d”, the FRC module 202 may generate the first signal S1 based on the sub-blue noise masks “c” and “d”. The FRC module 202 may determine whether the mask value of the target adjustment pixel falls within the sequence of mask values of the sub-blue noise mask “c” or “d”, where the mask value of the target adjustment pixel may be obtained by the dithering module 104 (for instance, the FRC module 202 and/or the spatial dithering module 206) based on the blue noise mask LUT shown in FIG. 6. The blue noise mask has 64×64 pixels, and each pixel has a corresponding mask value. The mask value of the target adjustment pixel may be obtained from this mask via a LUT, as shown in FIG. 6.

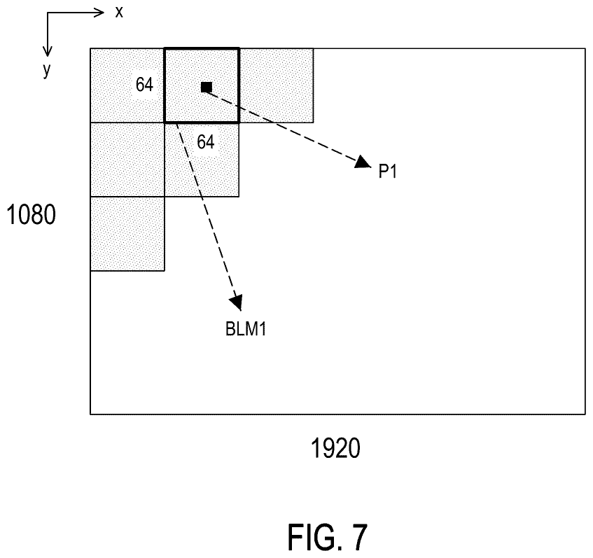

The dithering module 104 may use the blue noise mask to process the image signal (including the sub-image signals SF1 to SF8). Assuming that the image signal has a resolution of 1920×1080 as shown in FIG. 7, the blue noise mask BLM1 as shown in FIG. 6 includes 64×64 pixels. Hence, plural blue noise masks BLM1 are applied for processing the original image signal. In one embodiment, the blue noise masks BLM1 may be the same or different blue noise masks, and specific blue noise masks may be adopted at specific times. The FRC module 202 may obtain the corresponding mask value from the blue noise mask BLM1 based on the position of the target adjustment pixel in the corresponding sub-image signals SF1 to SF8. For instance, in FIG. 7, a coordinate position (x,y) of the target adjustment pixel P1 is (96,32). By respectively dividing the x-axis coordinate position and the y-axis coordinate position by 64 and taking the remainders, the coordinate position (32,32) of the target adjustment pixel P1 in the corresponding blue noise mask BLM1 may be obtained. Based on this coordinate position (32,32), the mask value 132 corresponding to the coordinate position (32,32) may be looked up from the blue noise mask LUT in FIG. 6. Similarly, the FRC module 202 may obtain the corresponding mask value of the blue noise mask for each pixel in the sub-image signals SF1 to SF8. A range of the mask values may be, for instance, 0 to 255, and the mask values are related to whether the display status of the pixel is “bright” or “dark”.

The FRC module 202 may generate the first signal S1 based on the looked-up mask value and at least one of the sub-blue noise masks “a” to “h” corresponding to the target adjustment pixel P1. For instance, the sequence of mask values of each of the sub-blue noise masks “a” to “h” has a mask value range (e.g., including consecutive integers). The sub-blue noise mask “a” is configured to set the display status of pixels with mask values within the range of 0-32 to “bright”; all others are set to “dark”. The sub-blue noise masks “b”, “c”, “d”, “e”, “f”, “g”, and “h” are designed to set the display status of pixels with mask values within the range of 33-64, 65-96, 97-128, 129-160, 161-192, 193-224, and 225-256 respectively to “bright”; otherwise, the display status is set to “dark”. For instance, the aforementioned (non-initial) sub-blue noise mask (which refers to a combination of plural sub-blue noise masks) corresponding to the time point t=1 and the FRC intensity value r=2 is a combination of the sub-blue noise masks “c” and “d”. The first signal S1 indicates that the mask value 132 of the target adjustment pixel P1 does not fall within the sequence of mask values of either of the sub-blue noise masks “c” and “d”. The FRC module 202 may, for instance, perform an “OR” operation on the output results of whether the mask value of the target adjustment pixel P1 falls within the sequence of mask values of the sub-blue noise masks “c” and “d” to generate the first signal S1. For instance, the result of the mask value of the target adjustment pixel P1 falling within the sequence of mask values of the sub-blue noise mask may be represented by a bit value “1”, and the output result of the mask value of the target adjustment pixel P1 not falling within the sequence of mask values of the sub-blue noise mask may be represented by a bit value “O” for performing the “OR” operation to generate the first signal S1. If the “OR” operation is performed and the mask value of the target adjustment pixel P1 is found in the sequence of mask values of the sub-blue noise mask “c” or “d”, the display status of the target adjustment pixel is set to “bright”; otherwise, it is set to “dark”. In this embodiment, since the mask value 132 of the target adjustment pixel does not fall within the sequence of mask values of either of the sub-blue noise masks “c” and “d”, the first signal S1 indicates that the display status of the target adjustment pixel is “dark”, i.e., the output result of the first signal S1 is the bit value “0”.

The rest may be deduced therefrom. If the input grayscale is 18, as mentioned above, its corresponding FRC intensity value “r” equals 4. According to the correspondence table shown in FIG. 5, at the time point t=1, the corresponding at least one of the sub-blue noise masks (non-initial sub-blue noise mask) is a combination of the sub-blue noise masks “e”, “f”, “g”, and “h”. The FRC module 202 generates the first signal S1 based on the sub-blue noise masks “e”, “f”, “g”, and “h”. The FRC module 202 performs an “OR” operation on the results of whether the mask value of the target adjustment pixel P1 falls within the sequence of mask values of the sub-blue noise masks “e”, “f”, “g”, and “h”. When the mask value of the target adjustment pixel P1 falls within the sequence of mask values of any one of the sub-blue noise masks “e”, “f”, “g”, and “h”, the display status of the target adjustment pixel P1 is set to “bright”. When the mask value of the target adjustment pixel P1 does not fall within the sequence of mask values of any of the sub-blue noise masks “e”, “f”, “g”, and “h”, the display status of the target adjustment pixel is set to “dark”. The first signal S1 correspondingly indicates the display status of the target adjustment pixel P1 as “bright” or “dark”. For instance, when the mask value 132 of the target adjustment pixel P1 falls within the sequence of mask values (129-160) of the sub-blue noise mask “e”, but not within the sequences of mask values of the sub-blue noise masks “f”, “g”, and “h” the display status of the target adjustment pixel P1 is set to “bright”. The first signal S1 correspondingly indicates the display status of the target adjustment pixel P1 as “bright”, i.e., the output result of the first signal S1 is the bit value “1”.

The spatial dithering module 206 may obtain the spatial sub-intensity value “s” based on the gray level LUT and obtain the sequence of mask values of the sub-blue noise mask (one of “a” to “h”) corresponding to the target adjustment pixel P1 based on the blue noise mask. The spatial dithering module 206 may calculate a numerical range based on the sequence of mask values of the sub-blue noise mask corresponding to the target adjustment pixel P1 and the spatial sub-intensity value s, where the sequence of mask values of the sub-blue noise mask corresponding to the target adjustment pixel P1 covers the mask value of the target adjustment pixel P1. The spatial dithering module 206 may obtain the mask value corresponding to the target adjustment pixel P1 based on the blue noise mask LUT and obtain the sequence of mask values of the corresponding sub-blue noise mask based on the mask value corresponding to the target adjustment pixel P1. In this embodiment, the sequence of mask values may be, for instance, a range of mask values being consecutive integers. The maximum value in the numerical range may be calculated, for instance, by the following equation (1).

R1=V1+(256/n)*(s/256) (1)
(or expressed as R1=V1+(s/n))

R1 is the maximum value in the numerical range, V1 is the minimum value in the sequence of mask values of the sub-blue noise mask (one of “a” to “h”) covering the mask value of the target adjustment pixel P1, which is also the minimum value in the numerical range, “n” is the number of the sub-image signals, and “s” is the spatial sub-intensity value. For instance, given the mask value v=132 of the target adjustment pixel P1, the corresponding spatial sub-intensity value s=69, and the sequence of mask values of the corresponding sub-blue noise mask “e” is 129-160, the spatial dithering module 206 may calculate the maximum value R1 of the numerical range to be 137.625 based on the equation (1), and the numerical range may be, for instance, 129 to 137.625. The spatial dithering module 206 may determine whether the mask value (132) of the target adjustment pixel P1 falls within the numerical range to generate the second signal S2. The second signal S2 indicates whether the mask value of the target adjustment pixel P1 falls within the numerical range, which is greater than or equal to V1 and less than or equal to R1. When the mask value of the target adjustment pixel P1 falls within the numerical range V1 to R1, the second signal S2 indicates that the display status of the target adjustment pixel is “bright”; that is, the output result of the second signal S2 is the bit value “1”. When the mask value of the target adjustment pixel does not fall within the numerical range, the second signal S2 indicates that the display status of the target adjustment pixel is “dark”; that is, the output result of the second signal S2 is the bit value “0”.

In other embodiments, the spatial dithering module 206 may determine the numerical range based on V1 and (256/n)*(s/256). Here, the maximum value R1 in the numerical range corresponds to a value at a position representing (256/n)*(s/256) (which may also be expressed as the s/nth value) in the sequence of mask values of the sub-blue noise mask (one of “a” to “h”) corresponding to the target adjustment pixel P1. The minimum value in the numerical range is the minimum value in the sequence of mask values of the sub-blue noise mask (one of “a” to “h”) covering the mask value of the target adjustment pixel P1. For instance, assuming that “n” equals 8 and “s” equals 128, the interpretation is that in the sequence of mask values of the sub-blue noise mask (one of “a” to “h”) corresponding to the target adjustment pixel P1, from V1 (the minimum value) to (256/n)*(s/256) (e.g., the 16th value), the corresponding display status is “bright”, while the remaining values correspond to the display status “dark”.

The logic operation selection unit 204 may obtain the first grayscale value “g0” and the second grayscale value “g1” based on the gray level LUT. The logic operation selection unit 204 may perform a logic operation based on the first signal S1 from the FRC module 202 and the second signal S2 from the spatial dithering module 206 and adjust the grayscale value of the target adjustment pixel P1 to the first grayscale value “g0” or the second grayscale value “g1” according to the result of the logic operation. The logic operation may be, for instance, an “AND” operation. For instance, the logic condition may be defined, such that when at least one of the first signal S1 and the second signal S2 indicates the display status of the target adjustment pixel is “dark”, namely, when the output result of at least one of the first signal S1 and the second signal S2 is the bit value “0”, the logic operation selection unit 204 adjusts the (original) grayscale value (the input grayscale) of the target adjustment pixel P1 to the first grayscale value g0. When both the first signal S1 and the second signal S2 indicate the display status of the target adjustment pixel is “bright”, namely, when the output results of both the first signal S1 and the second signal S2 are the bit value “1”, the logic operation selection unit 204 adjusts the (original) grayscale value (input grayscale) of the target adjustment pixel P1 to the second grayscale value g1. The control unit 106 may control the image unit 108 to display the target adjustment pixel as having the first grayscale value “g0” or the second grayscale value “g1” based on the adjustment result of the logic operation selection unit 204.

As derived from the above, the dithering module 104 may adjust the grayscale values for pixels at different positions in each sub-image signal. As shown in the gray level LUT in FIG. 4, most of the first grayscale values “g0” and the second grayscale values “g1” are different from the original grayscale values (the input grayscale), except for a few exceptional situations. For instance, when the input grayscale is 0, 44, or 61, at least one of the first grayscale value “g0” and the second grayscale value “g1” may be equal to the input grayscale. The dithering module 104 provided in this embodiment may create more grayscales through performing the aforementioned logic operations, thereby improving the display quality of the display device 100.

In the above embodiments, the image signal is divided into n=8 sub-image signals SF1 to SF8 for temporal dithering and spatial dithering, for instance. In other embodiments, depending on different resolutions and frame rates of the image signal, the image signal may be correspondingly divided into the sub-image signals of different quantities (e.g., 2 or 4, which should not be construed as a limitation to the invention) to optimize a bit depth, so as to achieve better display effects. For instance, a projection device (the display device 100) with a native resolution of 1080p and a screen refresh rate of 240 Hz is taken as an example; when the resolution of the image signal is 1080p and the frame rate is 30 fps, one frame (the image signal) may be split into 8 sub-frames (the sub-image signals), and thus the total frame rate becomes 240 fps. Similarly, when the resolution of the image signal is 1080p and the frame rate is 60 fps, one frame (the image signal) may be split into 4 sub-frames (the sub-image signals). When the resolution of the image signal is 4K, the frame rate is 60 fps, and the image signal is relatively static, one frame may be split into two sub-frames, where the content of the two sub-frames is basically the same or completely identical, and two 4K, 60 fps sub-frames may be combined into one 4K, 30 fps frame.

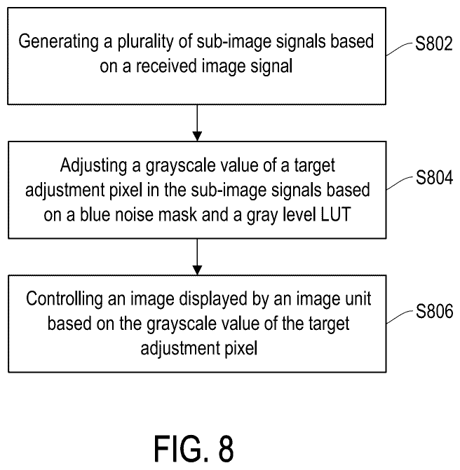

FIG. 8 is a flowchart of a display method of a display device according to an embodiment of the invention. From the above embodiments, it may be known that the display method of the display device 100 may include at least following steps. First, a plurality of sub-image signals are generated by a sub-image generation module 102 based on a received image signal (step S802). Next, a grayscale value of a target adjustment pixel P1 in the sub-image signals is adjusted by a dithering module 104 based on a blue noise mask and a gray level LUT (step S804). Finally, an image displayed by an image unit 108 is controlled by a control unit 106 based on the grayscale value of the target adjustment pixel P1 (step S806). The display device 100 may be, for instance, a projection device, the control unit 106 may be, for instance, a light valve controller, and the image unit 108 may be, for instance, a light valve. The light valve controller may control the mirror flipping of the light valve based on the grayscale value (the corresponding control signal) of the target adjustment pixel P1.

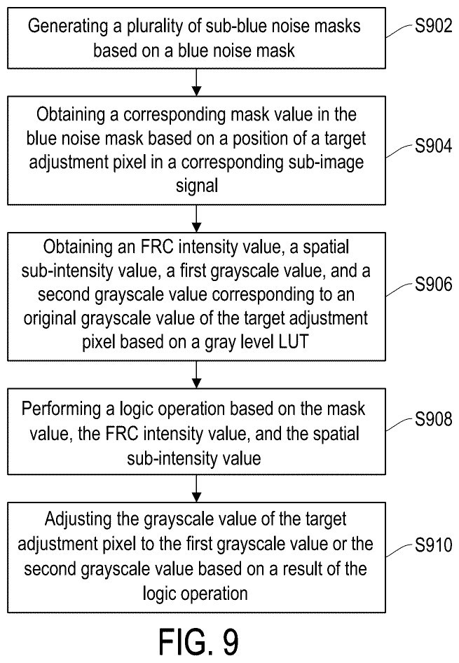

In this embodiment, step S804 may include steps S902 to S910 as shown in FIG. 9. First, a plurality of sub-blue noise masks “a” to “h” are generated by the dithering module 104 based on the blue noise mask (step S902). Next, the corresponding mask value is obtained from the blue noise mask by the dithering module 104 based on a position of the target adjustment pixel P1 in the corresponding sub-image signal (step S904). After that, an FRC intensity value r, a spatial sub-intensity value s, a first grayscale value g0, and a second grayscale value “g1” corresponding to the original grayscale value of the target adjustment pixel P1 are obtained by the dithering module 104 based on a gray level LUT (step S906). Afterwards, a logic operation is performed by the dithering module 104 based on the mask value, the FRC intensity value, and the spatial sub-intensity value (step S908), where the logic operation may be, for instance, an “AND” operation. Finally, the grayscale value of the target adjustment pixel P1 is adjusted to either the first grayscale value or the second grayscale value based on a result of the logic operation (step S910), where the first grayscale value “g0” may be different from the second grayscale value g1.

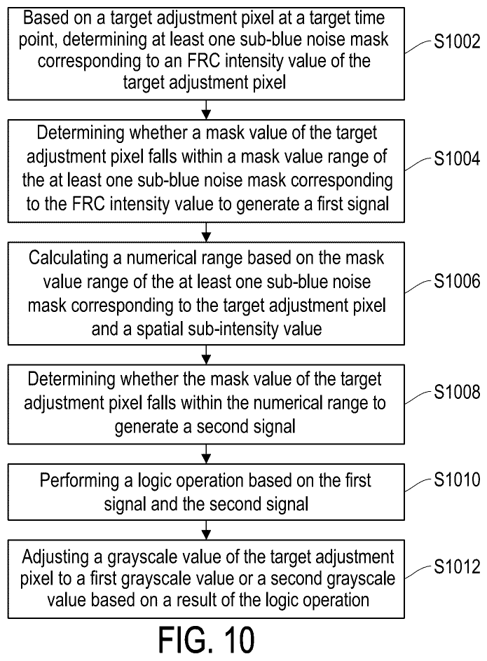

In this embodiment, the FRC intensity value “r” corresponds to at least one of the sub-blue noise masks “a” to “h”, each of the sub-blue noise masks “a” to “h” has a corresponding sequence of mask values, and a method of adjusting the grayscale value of the target adjustment pixel P1 may include performing steps S1002 to S1012 by the dithering module 104 as shown in FIG. 10. First, based on a target adjustment pixel P1 at a target time point “t” (that is, for the target adjustment pixel at the target time point), at least one sub-blue noise mask corresponding to an FRC intensity value “r” of the target adjustment pixel P1 is determined (step S1002). Then, whether a mask value of the target adjustment pixel P1 falls within a mask value range (a sequence of mask values) of the at least one sub-blue noise mask corresponding to the FRC intensity value “r” is determined to generate a first signal S1 (step S1004). The first signal S1 indicates whether a mask value of the target adjustment pixel P1 falls within the mask value range (the sequence of mask values) of the sub-blue noise mask, which corresponds to both the target time “t” and the FRC intensity value “r”. Afterwards, a numerical range is calculated based on the mask value range (the sequence of mask values) of the sub-blue noise mask corresponding to the target adjustment pixel P1 and a spatial sub-intensity value “s” (step S1006), where the mask value range (i.e., the sequence of mask values) corresponding to the sub-blue noise mask associated with the target adjustment pixel P1 includes the mask value of the target adjustment pixel P1, and the calculation method of the numerical range may be as shown in the aforementioned equation (1) and will not be repeated hereinafter. After that, whether the mask value of the target adjustment pixel P1 falls within the numerical range is determined to generate a second signal S2 (step S1008), where the second signal S2 indicates whether the mask value of the target adjustment pixel P1 falls within the numerical range. In an embodiment, as shown in FIG. 2, the step of generating the first signal S1 by the FRC module 202 (steps S1002 and S1004) and the step of generating the second signal S2 by the spatial dithering module 206 (steps S1006 and S1008) may be performed at the same time. Afterwards, a logic operation is performed based on the first signal S1 and the second signal S2 (step S1010), and a grayscale value of the target adjustment pixel P1 is adjusted to a first grayscale value or a second grayscale value based on a result of the logic operation (step S1012).

To sum up, the sub-image generation module provided in one or more embodiments of the invention generates the sub-image signals based on the received image signal, the dithering module adjusts the grayscale value of the target adjustment pixel in the sub-image signals based on the blue noise mask and the gray level LUT, and the control unit controls the image displayed by the image unit based on the grayscale value of the target adjustment pixel. This may effectively create more grayscales, significantly improving the display quality of the display device.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be configured to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A display device, comprising:
a sub-image generation module, configured to generate a plurality of sub-image signals based on a received image signal;
a dithering module, coupled to the sub-image generation module, and the dithering module comprising a blue noise mask and a gray level lookup table, wherein the dithering module is configured to adjust a grayscale value of a target adjustment pixel in the sub-image signals based on the blue noise mask and the gray level lookup table; and
a control unit, coupled to the dithering module and an image unit, and the control unit being configured to control an image displayed by the image unit based on the grayscale value of the target adjustment pixel.

2. The display device according to claim 1, wherein the control unit is a light valve controller, the image unit is a light valve, and the light valve controller is configured to control the light valve based on the grayscale value of the target adjustment pixel.

3. The display device according to claim 1, wherein the control unit is a display controller, the image unit is a display panel, and the display controller is configured to control the display panel based on the grayscale value of the target adjustment pixel.

4. The display device according to claim 1, wherein the dithering module is configured to generate a plurality of sub-blue noise masks based on the blue noise mask, obtain a corresponding mask value from the blue noise mask based on a position of the target adjustment pixel in a corresponding sub-image signal, obtain a frame rate conversion intensity value, a spatial sub-intensity value, a first grayscale value, and a second grayscale value corresponding to an original grayscale value of the target adjustment pixel based on the gray level lookup table, perform a logic operation based on the mask value, the frame rate conversion intensity value, and the spatial sub-intensity value, and adjust the grayscale value of the target adjustment pixel to the first grayscale value or the second grayscale value based on a result of the logic operation.

5. The display device according to claim 4, wherein the first grayscale value is different from the second grayscale value.

6. The display device according to claim 4, wherein the dithering module comprises a frame rate conversion module, a spatial dithering module, and a logic operation selection unit, and the frame rate conversion module and the spatial dithering module are respectively electrically connected to the logic operation selection unit, wherein
the frame rate conversion intensity value corresponds to at least one of the sub-blue noise masks, and each of the sub-blue noise masks has a corresponding sequence of mask values;
the frame rate conversion module is configured to determine, based on the target adjustment pixel at a target time point, at least one of the sub-blue noise masks corresponding to the frame rate conversion intensity value of the target adjustment pixel, and the frame rate conversion module is configured to determine whether the mask value of the target adjustment pixel falls within the sequence of mask values of at least one of the sub-blue noise masks corresponding to the frame rate conversion intensity value, so as to generate a first signal, the first signal is configured to indicate whether the mask value of the target adjustment pixel falls within the sequence of mask values of the at least one of the sub-blue noise masks corresponding to the target time point and the frame rate conversion intensity value;
the spatial dithering module is configured to calculate a numerical range based on the sequence of mask values of the at least one of the sub-blue noise masks corresponding to the target adjustment pixel and the spatial sub-intensity value, wherein the sequence of mask values of the at least one of the sub-blue noise masks corresponding to the target adjustment pixel covers the mask value of the target adjustment pixel, the spatial dithering module is further configured to determine whether the mask value of the target adjustment pixel falls within the numerical range, so as to generate a second signal, and the second signal is configured to indicate whether the mask value of the target adjustment pixel falls within the numerical range;
the logic operation selection unit is configured to perform the logic operation based on the first signal and the second signal from the frame rate conversion module and the spatial dithering module, and adjust the grayscale value of the target adjustment pixel to the first grayscale value or the second grayscale value based on the result of the logic operation.

7. The display device according to claim 6, wherein a maximum value in the numerical range is calculated by a following equation (1),
R1=V1+(256/n)*(s/256) (1)
wherein R1 is the maximum value in the numerical range, V1 is a minimum value in the sequence of mask values of the at least one of the sub-blue noise masks corresponding to the target adjustment pixel, “n” is the number of the sub-image signals, “s” is the spatial sub-intensity value, and V1 is the minimum value in the numerical range.

8. The display device according to claim 6, wherein a maximum value in the numerical range corresponds to a value at a position representing (256/n)*(s/256) in the sequence of mask values of the at least one of the sub-blue noise masks corresponding to the target adjustment pixel, and a minimum value in the numerical range is a minimum value in the sequence of mask values of the at least one of the sub-blue noise masks corresponding to the target adjustment pixel.

9. The display device according to claim 4, wherein the dithering module is configured to generate a corresponding number of the sub-blue noise masks based on the sub-image signals, the number of the sub-image signals is “n”, and “n” is an integer greater than or equal to 1.

10. A display method of a display device, comprising:
generating a plurality of sub-image signals by a sub-image generation module based on a received image signal;
adjusting a grayscale value of a target adjustment pixel in the sub-image signals by a dithering module based on a blue noise mask and a gray level lookup table; and
controlling an image displayed by an image unit based on the grayscale value of the target adjustment pixel by a control unit.

11. The display method of the display device according to claim 10, wherein the control unit is a light valve controller, the image unit is a light valve, and the light valve controller controls the light valve based on the grayscale value of the target adjustment pixel.

12. The display method of the display device according to claim 10, wherein the step of adjusting the grayscale value of the target adjustment pixel in the sub-image signals by the dithering module based on the blue noise mask and the gray level lookup table further comprises:
generating a plurality of sub-blue noise masks based on the blue noise mask;
obtaining a corresponding mask value from the blue noise mask based on a position of the target adjustment pixel in a corresponding sub-image signal of the sub-image signals;
obtaining a frame rate conversion intensity value, a spatial sub-intensity value, a first grayscale value, and a second grayscale value corresponding to an original grayscale value of the target adjustment pixel based on the gray level lookup table;
performing a logic operation based on the mask value, the frame rate conversion intensity value, and the spatial sub-intensity value; and
adjusting the grayscale value of the target adjustment pixel to the first grayscale value or the second grayscale value based on a result of the logic operation, wherein the first grayscale value is different from the second grayscale value.

13. The display method of the display device according to claim 12, wherein the frame rate conversion intensity value corresponds to at least one of the sub-blue noise masks, each of the sub-blue noise masks has a corresponding sequence of mask values, and the display method further comprises following steps performed by the dithering module:
based on the target adjustment pixel at a target time point, determining at least one of the sub-blue noise masks corresponding to the frame rate conversion intensity value of the target adjustment pixel;
determining whether the mask value of the target adjustment pixel falls within the sequence of mask values of the at least one of the sub-blue noise masks corresponding to the frame rate conversion intensity value, so as to generate a first signal, wherein the first signal is configured to indicate whether the mask value of the target adjustment pixel falls within the sequence of mask values of the at least one of the sub-blue noise masks corresponding to the target time point and the frame rate conversion intensity value;
calculating a numerical range based on the sequence of mask values of the at least one of the sub-blue noise masks corresponding to the target adjustment pixel and the spatial sub-intensity value, wherein the sequence of mask values of the at least one of the sub-blue noise masks corresponding to the target adjustment pixel covers the mask value of the target adjustment pixel;
determining whether the mask value of the target adjustment pixel falls within the numerical range, so as to generate a second signal, wherein the second signal is configured to indicate whether the mask value of the target adjustment pixel falls within the numerical range;
performing a logic operation based on the first signal and the second signal; and
adjusting the grayscale value of the target adjustment pixel to the first grayscale value or the second grayscale value based on a result of the logic operation.

14. The display method of the display device according to claim 13, wherein a maximum value in the numerical range is calculated by a following equation (1),
R1=V1+(256/n)*(s/256) (1)
wherein R1 is the maximum value in the numerical range, V1 is a minimum value in the sequence of mask values of the at least one of the sub-blue noise masks corresponding to the target adjustment pixel, “n” is the number of the sub-image signals, “s” is the spatial sub-intensity value, and V1 is a minimum value in the numerical range.

15. The display method of the display device according to claim 13, wherein a maximum value in the numerical range corresponds to a value at a position representing (256/n)*(s/256) in the sequence of mask values of the at least one of the sub-blue noise masks corresponding to the target adjustment pixel, and a minimum value in the numerical range is a minimum value in the sequence of mask values of the at least one of the sub-blue noise masks corresponding to the target adjustment pixel.
